(19) United States
(12) Patent Application Publication
(10) Pub. No.: US 2015/0188175 A1
(43) Pub. Date: Jul. 2, 2015

(54) POLYMER MEMBRANES WITH RARE EARTH OR TRANSITION METAL MODIFIERS

(71) Applicant: University of Central Florida Research Foundation, Inc., Orlando, FL (US)

(72) Inventors: Benjamin P. Pearman, Merritt Island, FL (US); Marianne Rodgers, Miscouche (CA); Nahid Mohajeri, Rockledge, FL (US); Robert Paul Brooker, Melbourne, FL (US); Darlene K. Slattery, Cocoa, FL (US)

(21) Appl. No.: 14/421,715

(22) PCT Filed: Aug. 14, 2013
(86) PCT No.: PCT/US2013/054975

§ 371 Date: Feb. 13, 2015

Related U.S. Application Data
(60) Provisional application No. 61/682,833, filed on Aug. 14, 2012.

(51) Int. Cl. H01M 8/10; H01M 4/92

(52) U.S. Cl. CPC H01M 8/1004; H01M 8/1018; H01M 4/92; H01M 4/921; H01M 2008/1095; H01M 2300/0082; H01M 2250/20

(57) ABSTRACT

A coated polymer membrane includes a polymer composite including a polymer material, a rare earth or transition metal compound modifier within at least a portion of a thickness of the polymer material. A median particles size of the compound modifier is between 20 nm and 150 nm. A precious metal group (PMG) metal or PMG metal alloy is coating both sides of the polymer composite.

### CROSS-REFERENCE TO RELATED APPLICATIONS

This application is a national stage application that claims priority to PCT/US13/54975 entitled “POLYMER MEMBRANES WITH RARE EARTH OR TRANSITION METAL MODIFIERS”, filed Aug. 14, 2013 which claims priority to provisional patent application 61/682,833 entitled “POLYMER MEMBRANES WITH RARE EARTH OR TRANSITION METAL MODIFIER”, filed Aug. 14, 2012, both of which are incorporated herein in their entireties.

### FIELD

Disclosed embodiments relate to polymer membranes and devices therefrom, for example, for polymer electrolyte membrane fuel cells.

### BACKGROUND

One application for polymer membranes is for polymer electrolyte membrane fuel cells (PEMFCs). The PEMFC includes a center membrane electrode assembly (MEA) which refers to an assembled stack of a proton exchange membrane (PEM) and an anode catalyst layer and cathode catalyst layer on opposing sides of the membrane. Gas diffusion layers sandwich the catalyst layers generally including platinum, followed by bipolar plates.

Perfluorosulfonic acids are generally used as the polymer membrane material for PEMFCs as it is proton permeable and is a dielectric material. However, membrane materials such as perfluorosulfonic acids are susceptible to degradation during PEMFC operation due to attacks on polymer chains from radicals such as OH. These radicals can be formed on the surface of the platinum catalyst in the presence of hydrogen and oxygen gas. Additionally, platinum tends to precipitate within the membrane, at a location defined by the partial pressures of hydrogen and oxygen, thereby forming a platinum band. The presence of the platinum band within the membrane is thought to accelerate membrane degradation due to radical formation and membrane attack.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments include polymer membranes formed from polymer composites which include a polymer material and a rare earth or transition metal compound modifier (additive), such as cerium oxide (ceria), titania or MnO₂. Polymer membranes having disclosed modifiers used for Precious Metal Group (PMG) metal catalyst coated membranes (CCMs) and related devices have been found to provide delocalized metal precipitation in the membrane by changing the PMG metal morphology and distribution within the membrane during operation, including minimizing the PMG metal dissolution and band formation in the membrane (e.g., for an in-situ-formed platinum band) and a concomitant improvement in membrane durability. The PMG metal can comprise gold, silver, or a platinum group metal which includes platinum, ruthenium, rhodium, palladium, osmium, and iridium.

A median particles size of the compound modifier is between 20 nm and 150 nm. Modifier particles being in the size range from 20 nm to 150 nm have been found for MEA and PEMFC applications to unexpectedly provide a significant reduction in proton conductivity degradation, fuel cell performance including reduced fluorine emission rate (FER) and open circuit voltage (OCV) stability as compared to both smaller particles (e.g., 2 nm to 5 nm) and larger particles (>300 nm).

### BRIEF DESCRIPTION OF THE DRAWINGS

FIG. 1A is a cross sectional depiction of an example catalyst coated membrane (CCM) including a disclosed polymer membrane having a disclosed rare earth or transition metal compound modifier, according to an example embodiment.

FIG. 1B is a membrane electrode assembly (MEA) including the CCM shown in FIG. 1A.

FIG. 2 is a cross sectional depiction a fuel cell including the MEA shown in FIG. 1B, according to an example embodiment.

FIG. 3A is a plot of platinum particle size (in nm) as a function of normalized distance of the Pt band from the cathode of a CCM, while FIG. 3B shows the fluorine emission rate (FER) for a 500 h OCV hold test for various CCMs including a disclosed ion exchange membrane including ceria nanoparticles from 20 nm 150 nm in size.

### DETAILED DESCRIPTION

Disclosed embodiments in this Disclosure are described with reference to the attached figures, wherein like reference numerals are used throughout the figures to designate similar or equivalent elements. The figures are not drawn to scale and they are provided merely to illustrate the disclosed embodiments. Several aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

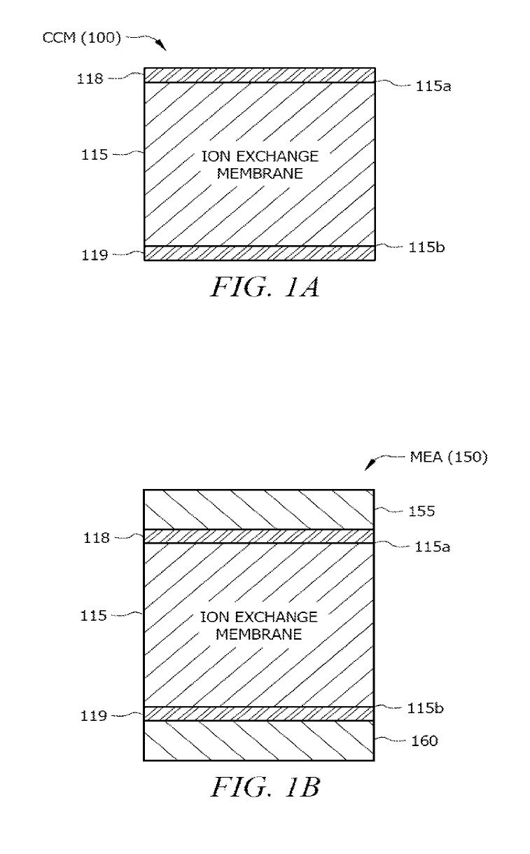

This Disclosure includes processes for forming a CCM, MEAs and fuel cells, such as PEMFCs, and CCMs, MEAs and PEMFCs therefrom. FIG. 1A is a cross sectional depiction of an example CCM 100 including a disclosed ion exchange membrane 115 comprising a polymer composite having a rare earth or transition metal compound modifier therein. Although ceria is generally described herein as the compound modifier, a variety of other rare earth or transition metal compound modifiers may also be used, such as oxides including manganese oxide and titania.

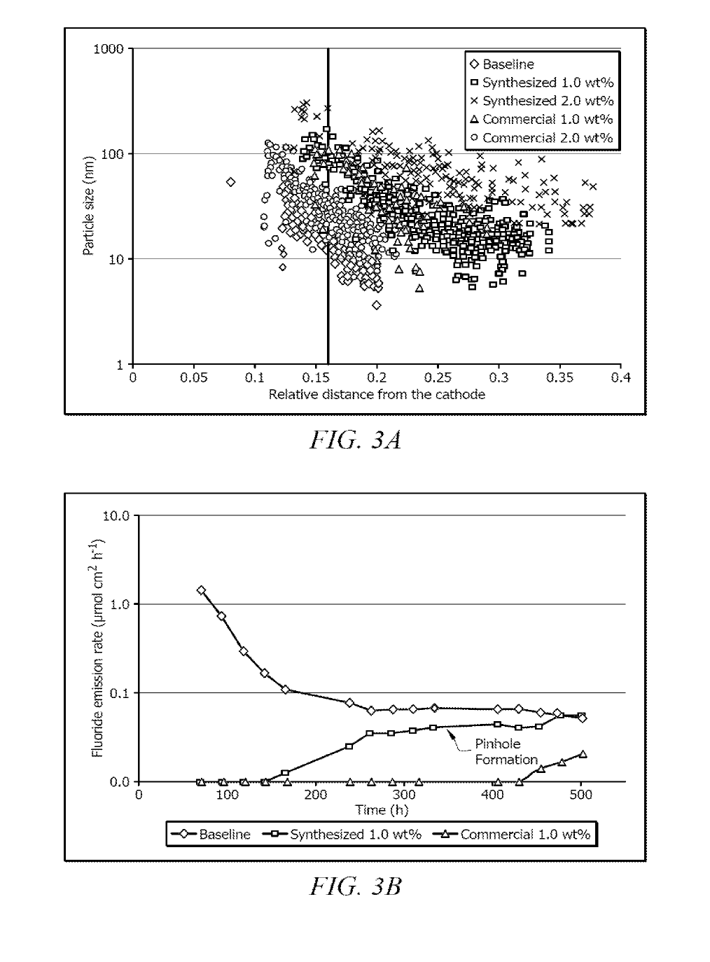

The median particles size of the modifier is between 20 nm and 150 nm, which as described herein was found to provide improved delocalization of platinum metal precipitation (e.g., see data in FIG. 3A described below) as compared to both smaller particles (e.g., 2 nm to 5 nm) and larger particles (>300 nm) which both exhibit a wider distribution of catalyst (e.g., Pt)-particles in the membrane. Typical modifier concentrations range from 0.5 to 2.0% versus the polymer material by weight, but may be higher or lower than this range, such as 0.2 to 5 wt. %.

The ion exchange membrane 115 typically used in PEM fuel cells comprises a solid polymer electrolyte which has a chemical structure similar to that of polytetrafluoroethylene (TEFLON). A conventional electrolyte material currently used in PEMFCs is a chemically stabilized perfluorosulfonic acid known as NAFION® that is typically 20 to 150 μm thick. The ion exchange membrane 115 has a cathode side 115a and an anode side 115b.

Besides perfluorosulfonic acid, hydrocarbons and partially fluorinated hydrocarbon proton exchange membranes and anion exchange membranes can be used, including, but not limited to sulfonated polyimides, sulfonated polystyrene, sulfonated polyetheretherketone, sulfonated polysulfones, sulfonated polyamides, sulfonated polyetherarylketones, sulfonated polyphenylene oxide, sulfonated polytrifluorostyrene, sulfonated polybenzimidazoles, sulfonated Diels Alder polyphenylene, and aminated polysulfones.

The catalyst layers 118 and 119 can comprise PGM metal (or PGM metal alloy) particles on carbon, homogenized with ionomer and solvents, with the solvent then removed to provide a porous electrically conductive solid material with carbon mixed with a polymer. The catalyst layer 118 and catalyst layer 119 can be applied to the ion exchange membrane 115 through various known methods, such as decal transfer, spray application or reactive spray deposition, to name a few. The interfaces where the catalyst layers 118, 119 and ion exchange membrane 115 make contact or are in close proximity of each other are generally referred to as electrode interfaces.

A common catalyst material used in PEM fuel cells is platinum, supported by carbon, as it generally provides excellent performance in reaction rates and durability. Platinum is generally alloyed with other metals, such as cobalt, ruthenium, or iridium to name a few, to improve the durability and performance of the catalyst. Other non-platinum based catalysts may also be used. In typical embodiments, the PGM metal or PGM metal alloy particles can comprise Pt, or PtCo (typically being 75 at. % Pt).

A particular production process is described for forming a disclosed composite membrane which comprises preparing a colloidal suspension of a rare earth or transition metal compound additive nanoparticles, such as cerium oxide (ceria) in a polymer electrolyte, and casting using a technique by incorporating a perfluorinated polymer support at the center of the composite membrane. Using a colloidal suspension ensures that the oxidation state of the rare earth or transition metal remains the same throughout the membrane formation process. Ensuring that the oxidation state of the metal in the modifier remains constant is recognized herein as an advantage because to maximize the delocalization of catalyst metal such as platinum in the membrane. In the case of ceria, for example, which contains a mixture of cerium in the Ce(III) and Ce(IV) states, a high (maximized) concentration of Ce(III) in the modifier is recognized to be needed for the delocalized Pt-precipitation effect described herein. For example, by suspending ceria in a liquid phase such as ethanol before applying to the membrane, the Ce(III) content in ceria is ensured to be unchanged during membrane manufacturing.

Disclosed embodiments recognize that for colloidal suspension to be formed the particles need to be between 1 nm to 250 nm in size, so that for example particle sizes larger than about 250 nm will not permit the formation of colloidal suspensions. The CCM in this process is prepared by spraying an ink containing an ionomer as an electrically conductive binder, a solvent and a catalyst (e.g., Pt/C or PtCo/C) onto the composite membrane, and then removing the solvent.

FIG. 1B is a cross sectional depiction of an example MEA 150 according to an example embodiment. MEA 150 includes the CCM 100 shown in FIG. 1A along with a cathode gas diffusion layer (GDL) 155 and an anode GDL 160. The GDLs can be bonded to the catalyst layers 118, 119 of the CCM 100 by known methods such as hot pressing.

The GDL of a fuel cell performs several important functions with its main purpose to deliver and remove reactants and products to the electrodes. This includes the removal of liquid water which can block the reactions sites on the cathode side of the fuel cell. The GDL also conducts both electrons and heat efficiently from the electrode layers to the flow channel plates. Because of this, the GDL is permeable to hydrogen (for PEMs) and oxygen, electrically and thermally conductive, and mechanically robust. In order to perform all of these functions, the GDL is typically porous. GDLs are usually 100 μm to 400 μm in thickness and are often treated with polytetrafluoroethylene (e.g., TEFLON) or another similar material in order to make them repel water in the case of PEM fuel cells.

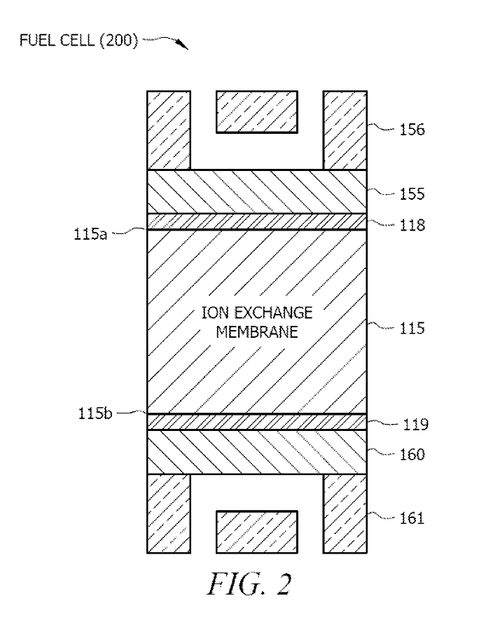

FIG. 2 is a cross sectional depiction of a fuel cell 200 including the MEA 150 shown in FIG. 1B, along with a cathode side flow plate 156 on the cathode GDL 155, and an anode side flow plate 161 on the anode side GDL 160 to deliver and remove reactants and products from the respective GDLs. The flow plates 156, 161 are typically formed from rigid and electrically conductive plates that give the fuel cell mechanical strength. When several fuel cells are placed in series and are in electrical contact with only one of these plates in-between each cell, these flow plates are referred to as bipolar plates. This is because they simultaneously serve as the anode and cathode plates for two different cells and functionally have two poles. Along with providing an electrically conductive path for electron flow, the bipolar plates give the fuel cell its structure.

Due to the fluorinated nature of conventional polymer electrolyte membranes, the eFER from the fuel cell during operation is accepted as a good indication of membrane degradation. As described in the Examples below, in liquid and gas Fenton testing, the FER for a disclosed PEM has been found to be reduced by an order of magnitude compared to a baseline membrane (not having rare earth or transition metal compound addition), significantly increasing membrane longevity. The in-situ durability improvement ability was also determined by subjecting disclosed CCMs to OCV hold accelerated durability tests for 94 hours and 500 hours. In the shorter test the OCV decay rate was reduced by half and the FER by at least one order of magnitude when compared to non-ceria containing CCMs (controls), with no effect on hydrogen crossover or performance of the baseline MEAs being observed. The Examples described below also evidence the effect of ceria additive particle size on Pt-band formation (FIG. 3A), and the particle size's stability in the membrane (FIG. 3B), with 20 nm to 150 nm ceria particles evidencing critical size range through the demonstration of superior properties and advantages that a person of ordinary skill in the relevant art would have found surprising or unexpected.

Advantages or benefits of disclosed embodiments over currently available technology include altering the Pt (or other catalyst) deposition during operation, resulting in increased Pt (or other catalyst) particle size and a more diffused Pt (or other catalyst) band in the membrane; two to three times larger particles; tenfold fewer particles; three to tenfold decrease in cross-sectional area concentration, resulting in a significantly increased lifetime of the membrane of a polymer electrolyte membrane fuel cell. Disclosed embodiments can be easily and inexpensively incorporated into current production methods, and do not impact performance negatively.

Uses for disclosed catalyst coated membranes include a wide range of applications including but not limited to PEMFCs for stationary or vehicular power generation, water electrolyzers, flow battery membranes for cation-based flow battery technologies (e.g. vanadium and/or hydrogen/bromine) and supercapacitors.

### EXAMPLES

Disclosed embodiments are further illustrated by the following specific Examples, which should not be construed as limiting the scope or content of this Disclosure in any way. Any mechanisms described below are believed to explain the observed reduction of membrane degradation provided by disclosed rare earth or transition metal compound modifiers for fuel cells. Although the mechanism described below is believed to be accurate, disclosed embodiments may be practiced independent of the particular mechanism(s) that may be operable.

Nanoparticle ceria was prepared by thermal hydrolysis. Ammonium hydroxide, 0.50 ml, (Fisher Scientific; 29.04%) can be added to 50 ml of a boiling solution of 0.02 M ammonium cerium nitrate (Acros Organics; 99.5% for analysis) in ethanol (Decon Labs; 200 proof) which, after the addition, was left to cool overnight under constant stiffing. The yellow precipitate of cerium oxide that formed was centrifuged, washed five times with 5 ml of ethanol and then dried at 100° C. under vacuum, yielding ca. 0.17 g of product with particle sizes in 2-5 nm range.

The synthesized ceria was dispersed in ethanol in a Branson 2510 ultrasound bath using sonication at 40 kHz to give 7 mM colloidal dispersions in ethanol. Using the same technique, 7 mM dispersions of a commercial cerium oxide powder (Alfa Aesar; 99.9% min (REO), 20-150 nm) in ethanol were also prepared.

PFSA membranes were cast onto a porous PTFE support (Donaldson Filtration Solution; TETRATEX® membrane; 7 μm) from solutions of 5% 1100 EW PFSA dispersions in alcohols (Ion Power, Inc.), ethanol and dimethylformamide (Acros Organics; 99.5% for HPLC) in a 5.8:4.0:1.0 volume ratio. Ceria was incorporated by replacing some of the ethanol with appropriate amounts of the ethanol dispersions to yield 0.5, 1.0 and 2.0 weight percent of cerium oxide relative to the polymer mass. Membranes without ceria were also cast as baselines. After room temperature drying, membranes were heated at 150° C. for three hours under vacuum after purging three times with UHP nitrogen to remove all residual solvent.

The MEA fabrication can comprise a homogenized dispersion of a platinum on carbon powder (Tanaka; 46.7% Pt on C) in a methanol (Acros Organics; 99.9% for HPLC), deionized water and 5% 1100 EW PFSA in alcohol (Ion Power, Inc.) mixture sprayed onto the membranes to give 25 cm² catalyst coated membranes (CCMs). Catalyst loadings were determined gravimetrically and kept at 0.375±0.025 gPt cm⁻². The CCMs were ion-exchanged with cesium ions by immersing in a 0.05 M CsCO₃ (Alfa Aesar; 99% (metals basis)) solution overnight, followed by a 5 min hot press at 180° C. and then reprotonated by immersion in 0.5 M H₂SO₄ (BDH; 95.0%). The CCMs were built into 25 cm2 hardware (Fuel Cell Technologies) with gas-diffusion layers (GDL) purchased from Ion Power, Inc. (Sigracet 10BC).

Tests were performed to evaluate MEA performance of a Pt catalyst vs. other catalysts including PtCo. For example, the open circuit voltage (OCV) decay rate was reduced by ½ to ⅓ and the fluoride emission reduced by an order of magnitude when PtCo/C was used rather than conventional Pt/C in the electrodes of the MEA. The choice of catalyst was also found to also influence durability, where using a PtCo/C catalyst results in a ˜10-fold reduction in FER after 100 h AST compared to a conventional Pt/C catalyst.

The incorporation of ceria was found to cause a broadening of the platinum band with particles reaching further into the membrane. Use of PtCo/C rather than Pt/C in the electrode similarly broadens the distribution of Pt across the membrane. In 500 hour tests, ceria-containing MEAs demonstrated a seven-fold decrease in open-circuit voltage (OCV) decay and a three order of magnitude reduction in fluoride emission rates with unchanged performance and hydrogen crossover, remaining effectively pristine whilst the baseline MEA became unusable. The presence of an example ceria modifier was found to increase the platinum particle size and decrease the number of platinum catalyst particles deposited in the membrane.

Cerium oxide was incorporated, at three concentration levels (0.5, 1.0 and 2.0 weight percent of cerium oxide relative to the polymer mass into polytetrafluoroethylene (PTFE)-supported, composite PFSA membranes) by casting from a dispersion of PFSA in alcohols and dimethylformamide. Membranes without ceria were also cast as baselines (controls). An aberration-corrected JEOL 2200FS TEM/STEM instrument equipped with a Bruker Quantax EDS detector was used to perform scanning transmission electron microscopy (STEM) and energy dispersive X-ray spectroscopy (EDS) on ceria powders. Scanning electron microscopy (SEM) imaging of membrane cross-sections was performed on a Hitachi TM3000 SEM with an integrated Physical Electronics 5400 EDS sensor.

Transmission UV/Vis spectra were obtained on a Shimadzu UV-2401PC. ¹⁹F-NMR measurements were performed on a Varian VNMRS 500 MHz instrument. The resistance of membranes was measured using a Princeton Applied Research Potentiostat/Galvanostat Model 263A by performing cyclic voltammetry from −0.3 to 0.3 V at a rate of 30 mV s⁻¹ on a piece of membrane in a 4-probe BekkTech conductivity cell under a 1000 cm³ min⁻¹ hydrogen gas flow (Airgas, Inc.; UHP) at 80° C. The relative humidity of the gas stream was varied from 20 to 90% and the in-plane conductivity of the membranes was calculated based on the initial membrane dimensions.

For Fenton tests, membranes were ion-exchanged with Fe²⁺ ions by immersing in a 200 ml solution of FeSO₄ (Acros Organics; 99.5% for analysis) in a mole ratio of 10:1 of protons to Fe²⁺. For liquid Fenton tests (LF), Fe²⁺ ion-exchanged membranes were immersed in 3.0% hydrogen peroxide solutions (VWR; diluted from 30%; ACS Grade) under reflux conditions at 80° C. for 48 hours. After 24 hours, using test strips (EMD Chemicals; 100-1000 mg dm⁻³ H₂O₂), the hydrogen peroxide was found to be completely decomposed and hence the solution was replaced to replenish the hydrogen peroxide content.

Fe²⁺ ion-exchanged membranes, in an 80° C. reaction chamber, were exposed to a 50 cm³ min⁻¹ flow of nitrogen gas (Airgas, Inc.; UHP) that was previously bubbled through a 60 C solution of 30% hydrogen peroxide. Off-gases were passed through a potassium hydroxide solution (VWR; 0.1 M; Baker Analyzed) that trapped any degradation products. Fluoride concentrations for the Fenton tests were measured by ion chromatography on a Dionex ICS-1500 equipped with AS9-HC carbonate eluent anion-exchange column

### Results and Discussion

Regarding membrane proton conductivity, one important metric of an ionomer's suitability as an ion exchange membrane for PEM fuel cells is its ability to conduct protons. PFSA ionomers used in fuel cells are able to transport protons by either diffusion through absorbed water or by the Grotthus mechanism. If modifiers inhibit either of these two mechanisms, their incorporation into PFSA membranes can have a detrimental effect on proton conduction and therefore performance.

The experimental method for proton conductivity measurements used involved holding membranes at various relative humidity levels and allowing enough time for the membrane to reach a steady-state condition. However, for disclosed ceria-containing membranes, the conductivity was found to slowly but continually decrease over time, with a concurrent decrease in membrane opacity.

Over 30 hours of measurement, no significant change in the conductivity of the baseline material was observed, yielding a typical value of 35 mS cm⁻¹ for PFSA membranes. Both disclosed ceria-containing membranes, on the other hand, show a greater than three-fold decrease in proton conductivity and did not reach a minimum even after 18 and 90 hours of testing for the synthesized ceria (2 nm to 5 nm) and commercial ceria (20 nm to 150 nm), respectively, where the increase in proton conductivity for the synthesized ceria at ˜18 hours is discussed further below.

In order to gain a better understanding of the loss in membrane opacity and decrease in proton conductivity, further tests were conducted. SEM images of the cross sections of the synthesized ceria-containing membrane before and after 18 hours of measurements at 80° C. and 70% RH, were taken end evaluated. Before testing, the precipitation of ceria onto the PTFE support was clearly visible as an intermittent band of white nanoparticles. These agglomerates were confirmed by EDS analysis to contain cerium were no longer observable after conductivity testing.

However, EDS mapping of a six hour tested membrane demonstrated the presence of cerium, as seen by an intense band. The ceria particles were found to be highly dispersed which was considered as one of the causes leading to the decrease in opacity.

To probe any changes in the chemical nature of the ceria and further understand the loss of opacity, UV/Vis spectroscopy measurements were performed. Ce(III) and Ce(IV) absorb strongly in the ultraviolet spectrum; 252 and 298 nm for ionic solutions, respectively. The UV/Vis spectra of 2.0 wt % ceria-containing membranes, before and after proton conductivity measurement, were taken. Prior to testing, both synthesized and commercial ceria membranes absorb over a broad range from 225 to 400 nm. After conductivity measurements, a change in the spectra was observed with the appearance of a strong peak around 255 nm, an absorbance characteristic of Ce³⁺. A baseline membrane that was ion-exchanged with Ce³⁺ yielded a UV/Vis spectrum that mirrored the absorbance of the tested membranes, indicating the conversion of cerium oxide to Ce³⁺ ions.

It is known that in highly concentrated solutions (>8 M) of sulfuric acid at high temperatures (>80° C.), cerium oxide will dissolve and react to form Ce(III) ions, as shown in Eq. (1) below:

CeO₂+12H⁺→4Ce³⁺+6H₂O+O₂ (1)

PFSAs are considerably more acidic than H₂SO₄ (pKₐ of −6 and −3, respectively). It is believed that during the humidification process and exposure to flowing gases, the cerium oxide particles disperse, and are reduced to cerium(III) ions in the manner shown in Eq. (1). The Ce³⁺ ions bind to the sulfonate groups resulting in decreased proton conductivity. This conclusion was further confirmed upon reprotonation. After 18 hours of testing, the synthesized ceria membrane was immersed in 0.5 M sulfuric acid. This not only returned the membrane's proton conductivity to its original value, but also the 255 nm peak in the UV/Vis spectrum disappeared, leaving an absorbance spectrum that was identical to that of a baseline membrane. This further confirmed the ionization of the ceria. The immersion in acid removed the Ce³⁺ bound to the sulfonate groups and replaced them with protons.

One of the goals herein was to investigate the effect of the ceria formulation on Pt-band formation and degradation mitigation. In the previous OCV hold tests, little variation between the synthesized ceria (2 nm to 5 nm) and commercial ceria (20 nm to 150 nm) powders was observed. However, in the proton conductivity measurements, a significant difference in kinetics of reduction was detected, with commercial ceria (20 nm to 150 nm) providing significantly less proton conductivity degradation. From high magnification STEM imaging taken, it was demonstrated that the synthesized ceria consisted of polycrystalline nanoparticles with a very uniform size distribution of 2 nm to 5 nm, while the commercial ceria consisted of faceted particles with sizes on the order of 20 nm to 150 nm.

The low magnification STEM images evidenced both formulations agglomerated and tended to precipitate from the colloidal dispersions, with the commercial material (20 nm to 150 nm) falling out faster due to the larger particle sizes. This difference in size is also believed to explain the difference in kinetics. The ceria reduction reaction above is a surface reaction and due to its higher surface area to volume ratio, the ionization occurs faster for the smaller synthesized 2 nm to 5 nm ceria than for the 20 nm to 150 nm commercial ceria, leading to a slower decrease in proton conductivity for the 20 nm to 150 nm (“commercial”) as compared to the 2 nm to 5 nm ceria (“synthesized”).

Further experiments showed that the reduction occurred even when the membranes were not exposed to cyclic voltammetry or placed in contact with the platinum electrodes, as well as when inert gases were used in place of hydrogen. This phenomenon is significant as the ionization increases the probability of the radical scavenger leaving the membrane during fuel cell operation and becoming ineffective. 500 h OCV hold tests demonstrated significant long-term durability improvements with no significant impact on performance.

In accelerated in-situ fuel cell testing, ceria was found to be highly effective at reducing membrane degradation, so effective that the emission of fluoride was found to be below the limit of quantification of the ion chromatograph, for all ceria concentrations used. As it was of interest to ascertain the ceria loading effect on membrane durability, series of gas and liquid Fenton test were conducted. Since chemical membrane degradation is primarily driven by hydroxyl radicals, the Fenton test has been used as an ex-situ accelerated durability test method for hydrogen fuel cell membranes. This involves exposing a membrane to hydrogen peroxide in the presence of catalytic amounts of Fe²⁺, which results in the formation of the destructive hydroxyl radicals (Eq. 2).

Fe²⁺+H₂O₂+H⁺→Fe³⁺+H₂O+HO. (2)

As mentioned, ceria derives its ability to scavenge radicals by being able to facilely switch the oxidation states of the cerium ions within its lattice. The scavenging reaction of HO. by the Ce³⁺ ion is given in Eq. (3). Ceria can act catalytically by returning to its Ce(IV) oxidation state through reaction with hydrogen peroxide, as shown in Eq. (4), or the hydroperoxyl radical, as shown in Eq. (5) below.

Ce³⁺+HO+H⁺→Ce⁴⁺+H₂O (3)

Ce⁴⁺+H₂O₂→Ce³⁺+HOO.+H⁺ (4)

Ce⁴⁺+HOO.→Ce³⁺+O₂+H⁺ (5)

Experiments were performed to obtain results for Fe²⁺ ion-exchanged membranes exposed to liquid and gaseous hydrogen peroxide, respectively. In both tests, ceria provides a large decrease in the FE, a degradation mitigation effect that increases with increasing modifier concentration up to an order of magnitude for the 2.0 wt % ceria-containing membranes. The durability improvement is independent of the ceria formulation and therefore particle size. There are two possible explanations for this counterintuitive result. For one, it is possible that the Fenton tests are not precise enough to resolve the slight differences in activity between the two similar materials. It is also here considered that this observation is a consequence of the reaction described earlier for proton conductivity measurements that is given in Eq. (1). In the conditions encountered in either of the two Fenton tests, cerium oxide is again reduced to cerium ions. As the amount of cerium ions in each formulation is effectively the same, once ionized they provide the same level of protection from radical attack.

However, for the LF, the initial FE reduction is significantly more pronounced than for the GF. It is thought that this difference is a consequence of the different reaction mechanisms that are effective in the different phases. This variation in reaction mechanism is also the reason that the two Fenton tests were employed. It was of interest to obtain as comprehensive a picture of ceria's mitigation ability as possible, while also analyzing the validity of the two tests as accelerated durability tests for polymer electrolyte membranes for hydrogen fuel cells.

In solution, the majority of hydroxyl radicals that are formed react with the large amounts of available hydrogen peroxide much faster than with the low concentrations of vulnerable polymer groups. This reaction, given in Eq. (6) below, produces the less reactive HOO. In the vapor phase of the GF on the other hand, the HO. that is formed is not in close contact with many other H₂O₂ molecules. The hydroxyl radical's greater kinetics in reactions with susceptible polymer groups results in greater membrane degradation. Higher concentrations of ceria increase the likelihood of quenching and consequently have a greater impact on the fluoride emission in the GF than in the LF, where the radical attack is already greatly reduced.

HO.+H₂O₂→HOO.+H₂O (6)

Further experiments were performed which evidence the significantly improved performance of disclosed CCMs having 20 to 150 nm rare earth or transition metal compound additives therein by comparing the performance of a baseline (no ceria) membrane, disclosed ion exchange membrane including ceria nanoparticles from 20 nm 150 nm in size (“commercial” ceria) and ion exchange membrane including ceria nanoparticles from 2 nm 5 nm in size (“synthesized” ceria). These experiments all utilized PTFE-supported composite perfluorosulfonic acid hydrogen fuel cell membranes coated with a platinum on carbon catalyst.

FIG. 3A is a plot of Platinum particle size (in nm) as a function of normalized distance from the cathode of a CCM. The basic shape of the particle size-distance distribution is similar for all MEAs. The vertical black line in FIG. 3A indicates the theoretical distance of the Pt band from the cathode, calculated as a function of hydrogen and oxygen partial pressures. With increasing distance from the cathode, the particles decreased in both size and number. For the ceria-containing MEAs, the Pt particles were noticeably larger and the band extended much further into the membrane than for the baseline MEA. It should be noted that very small Pt particles (<3 nm), observed in some cases beyond the Pt band and, to a lesser extent, between the cathode and onset of the Pt band, were not included in the measurements.

It is thought that the nanoparticles are formed by the reduction of diffusing Pt ions by H₂ crossing over from the anode. Due to the crossover of both hydrogen and oxygen, a potential profile for an MEA in a running fuel cell is present, which has been modeled as a function of partial gas concentrations. Deposition mainly occurs at the point where the potential rapidly decreases to 0 V, resulting in the formation of the intense band, though particles do form further in the membrane, due to inhomogeneities in the gas crossover and the presence of seeding points.

The decrease in the number of particles in the Pt bands of ceria containing membranes demonstrates that ceria influences the behavior of dissolved Pt ions. As all MEAs showed a similar decrease in ECA, it is unlikely that ceria prevents catalyst dissolution. The observation that particles extend further into the membrane, sometimes even all the way to the anode, suggests that the presence of ceria changes the potential profile. Inventor Brooker et al. has shown that the inclusion of redox-active heteropolyacids in a sublayer between the catalyst and the membrane, perturbs the potential profile resulting in the deposition of the metal in said sublayer. It is believed here that a similar mechanism is at play. It is considered that the ceria particles, to some extent, influence the point at which the potential decreases to 0 V, thereby broadening the band.

Radicals can form on platinum from reactions of hydrogen and oxygen. On large particles these radicals are more likely to be quenched before escaping the surface than on smaller particles. This evidences that in ceria-containing MEAs where larger, and fewer, particles were present, the Pt band contributes significantly less to degradation than in the baseline.

To ascertain cerium oxide's radical scavenging ability over long periods of time, 500 h OCV hold tests were performed on a baseline, a synthesized 1.0 wt % (2 nm to 5 nm “synthesized” ceria particles) and commercial (20 nm to 150 nm “commercial” ceria particles) 1.0 wt % MEA with the fluoride emission rates (FER) for a 500 h OCV hold test results shown in FIG. 3B. The FER actually decreased with little further degradation occurring after 150 h, due to the lack of membrane to degrade. If more membrane had been available, it is clear that the baseline MEA's total emission of fluoride would have been much greater.

The fluoride emission of the first 140 h for the synthesized ceria 1.0 wt % and 400 h for the commercial ceria 1.0 wt % MEAs were below the limit of quantification, a substantial improvement over the baseline material. Based on the LOQ, the FER of the ceria containing MEAs was two orders of magnitude lower, values in line with those obtained for cerium ion-exchange. Surprisingly, the defect in the synthesized 1.0 wt % MEA did not impact the FER. Prior to the pinhole formation, it had already released approximately half of the total fluoride measured during the experiment. This failure was, therefore, considered to be localized and not representative of the whole membrane. The amount of fluoride released was still one order of magnitude lower than the baseline membrane. Throughout the 500 h of the experiment, the commercial 1.0 wt % MEA lost less than one percent of its total fluorine inventory and showed no change in membrane thickness.

### CONCLUSIONS

Two formulations of crystalline cerium oxide nanoparticles, an in-house synthesized material of 2 nm to 5 nm and a commercial ceria material of an order of magnitude larger ceria particle size from 20 nm to 150 nm, were incorporated into perfluorosulfonic acid membranes. Upon exposure of the membranes to flowing, humid gas, the ceria particles with Ce⁺⁴ were found to be reduced to Ce³⁺ ions due to the highly acidic environment of PFSA membranes, a factor which greatly impacts proton conductivity. In ex-situ accelerated durability liquid and gas Fenton testing, the ceria particles reduced fluoride emission by up to one order of magnitude due to the cerium's ability to scavenge hydroxyl and hydroperoxyl radicals. The degradation mitigation was found to increase with increasing modifier concentration, with the membrane degradation mitigation particularly improved using 20 nm to 150 nm modifier particles as compared to 2 nm to 5 nm modifier particles evidencing a critical size range through the demonstration of superior properties and advantages that a person of ordinary skill in the relevant art would have found surprising or unexpected.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

1. A coated catalyst membrane (CCM), comprising:
polymer composite, including
a polymer material;
a rare earth or transition metal compound modifier within at least a portion of a thickness of said polymer material, wherein a median particles size of said compound modifier is between 20 nm and 150 nm, and
a precious metal group (PMG) metal or PMG metal alloy coating on both sides of said polymer composite.

2. The CCM of claim 1, wherein said compound modifier comprises cerium oxide (ceria).

3. The CCM of claim 2, wherein said compound modifier is uniformly distributed throughout said thickness and is from 0.5 to 2.0% of said polymer material by weight.

4. The CCM of claim 1, wherein said polymer composite is formed by a process comprising preparing a colloidal suspension including particles of said compound additive in a liquid phase polymer electrolyte, and casting said colloidal suspension mixed with said polymer material.

5. The CCM of claim 1, wherein said PMG metal or PMG metal alloy coating comprises Pt.

6. The CCM of claim 5, wherein said PMG metal alloy coating comprises PtCo.

7. A membrane electrode assembly (MEA), comprising:
an ion exchange membrane comprising a polymer composite having a cathode side and an anode side;
a cathode catalyst comprising a precious metal group (PMG) metal or PMG metal alloy coating on said cathode side;
an anode catalyst comprising a PMG metal or PMG metal alloy coating on said anode side,
wherein said polymer composite includes;
a polymer material;
a rare earth or transition metal compound modifier within at least a portion of a thickness of said polymer material, wherein a median particles size of said compound modifier is between 20 nm and 150 nm,
a cathode gas diffusion layer (GDL) in said cathode catalyst, and
an anode GDL on said anode catalyst.

8. The MEA of claim 7, wherein said polymer composite is formed by a process comprising preparing a colloidal suspension including particles of said compound additive in a liquid phase polymer electrolyte, and casting said colloidal suspension mixed with said polymer material.

9. The MEA of claim 7, wherein said compound modifier comprises cerium oxide (ceria).

10. The MEA of claim 7, wherein said compound modifier is uniformly distributed throughout said thickness and is from 0.5 to 2.0% of said polymer material by weight.

11. The MEA of claim 7, wherein said PMG metal or PMG metal alloy coating comprises Pt.

12. The MEA of claim 7, wherein said PMG metal alloy coating comprises PtCo.

13. A fuel cell, comprising:
a membrane electrode assembly (MEA), comprising:
an ion exchange membrane comprising a polymer composite having a cathode side and an anode side; and
a cathode catalyst comprising a precious metal group (PMG) metal or PMG metal alloy coating on said cathode side;
an anode catalyst comprising a PMG metal or PMG metal alloy coating on said anode side,
wherein said polymer composite includes;
a polymer material;
a rare earth or transition metal compound modifier within at least a portion of a thickness of said polymer material, wherein a median particles size of said compound modifier is between 20 nm and 150 nm,
an anode side gas diffusion layer (GDL) on said anode catalyst and an anode side flow plate on said anode side GDL;
a cathode side GDL on said cathode catalyst and cathode side flow plates on said cathode side GDL,
a cathode side flow plate on said cathode GDL, and an anode side flow plate on said anode side GDL.

14. The fuel cell of claim 13, wherein said polymer composite is formed by a process comprising preparing a colloidal suspension including particles of said compound additive in a liquid phase polymer electrolyte, and casting said colloidal suspension mixed with said polymer material.

15. The fuel cell of claim 13, wherein said compound modifier comprises cerium oxide (ceria).

16. The fuel cell of claim 13, wherein said compound modifier is uniformly distributed throughout said thickness and is from 0.5 to 2.0% of said polymer material by weight.

17. The fuel cell of claim 13, wherein said PMG metal or PMG metal alloy coating comprises Pt.

18. The fuel cell of claim 17, wherein said PMG metal alloy coating comprises PtCo.
